(19) United States
(12) Patent Application Publication
(10) Pub. No.: US 2017/0240399 A1
(43) Pub. Date: Aug. 24, 2017

(54) MILK DISPENSER

(71) Applicant: MILKIT ISRAEL LTD., HERZELIYA (IL)

(72) Inventor: ASSAF BLANK, HERZELIYA (IL)

(73) Assignee: MILKIT ISRAEL LTD., HERZELIYA (IL)

(21) Appl. No.: 15/310,180

(22) PCT Filed: May 17, 2015
(86) PCT No.: PCT/IL2015/050524

§ 371 Date: Nov. 10, 2016

Related U.S. Application Data
(60) Provisional application No. 61/993,299, filed on May 15, 2014.

(51) Int. Cl. B67D 1/00; F25D 31/00; B67D 1/08; F25D 19/00; A47J 31/46; B67D 1/10

(52) U.S. Cl. CPC B67D 1/0004; A47J 31/46; B67D 1/10; B67D 1/0857; B67D 1/0801; F25D 19/00; F25D 31/006; F25D 2331/801

(57) ABSTRACT

A dispenser for dispensing milk from a bulk container. The dispenser is mounted outside of a refrigerator and the bulk container is stored within the refrigerator. The dispenser is provided with means for conveying the milk from the bulk container to a pouring spout. Several bulk containers may be connected together to form a large bulk container of milk that is kept refrigerated in its entirety.

### FIELD OF THE INVENTION

The present invention relates to the field of machines for coffee making facilities like coffee shops and restaurants, and more particularly to the field of milk dispensing machines for such facilities.

### BACKGROUND OF THE INVENTION

In order to prepare a cup of coffee by means of a coffee machine in a coffee shop or the like, the operator (being a barman or the like) has to pour milk on the cup of coffee. Typically, in order to receive a nice pouring effect, the milk is foamed by a steamer.

The most common milk packages available in the market are plastic bags or carton containers having a volume of one liter. Since the carton containers are more expensive than the plastic bags, the majority of use is of plastic bags. In order to use the milk, the operator often has to take a milk bag from a refrigerator, put it into a bag holding vessel, and cut an edge of the plastic bag in order to prepare it for use. Now, each time milk is required, milk is poured from the bag holding vessel into a foaming jug.

This process encounters several disadvantages. First, the process of repeatedly taking a milk plastic bag from the refrigerator, putting it into a bag holding vessel and cutting an edge of the bag requires time and attention of the operator. Second, the bag holding vessel utilizes precious space on the counter. Third, the milk in the bag holding vessel is not refrigerated, a fact that causes problems when foaming the milk since it is advantageous to use refrigerated mild for foaming Fourth, the cutting of a plastic bag edge, and, leaving it open, are both unsterile processes. Fifth, the constant throwing of the empty plastic bags contributes to excessive littering and negatively affecting the environment.

There are various publications showing refrigerators having a dispensing pump for bulk fluids therein, and even for a milk jug, as shown, for example, in

US Publication No. US2011/0303693 to Culley et al. The disadvantage of such systems is that the milk dispensing system forms a part of a large refrigerator and therefore cannot be used with coffee machines as described above.

It is the object of the present invention to provide a milk dispenser that significantly reduces or overcomes the aforementioned disadvantages.

It is a further object of the present invention to provide a bulk milk dispenser that enables using milk at a constant refrigerated temperature.

It is still a further object of the present invention to provide a bulk milk dispenser that is hygienic and easy to use.

It is yet a further object of the present invention to provide a bulk milk dispenser that has small dimensions and can be easily located on top of a commercial refrigerator or on the bar.

### SUMMARY OF THE INVENTION

The invention enables to use bulk quantities of refrigerated milk, without being dependent on a refrigerator, in a quick, sterile and efficient manner

According to the present invention there is provided a dispenser for dispensing liquid from a bulk container, the dispenser being mounted outside of a refrigerator and comprises:

means for conveying the liquid from the bulk container to a pouring spout.
Practically, the dispenser constitutes a milk dispenser.
Further practically, the bulk container constitutes a milk bulk container.
Advantageously, the bulk container is stored within the refrigerator.
In some embodiments, the means for conveying the liquid from the bulk container to the pouring spout comprising:

a pump having an inlet hose and an outlet hose, and

operation means for dispensing a required amount of liquid, wherein:

an inlet pipe is connected between the inlet hose and the bulk container;

an outlet pipe is connected between the outlet hose and the pouring spout; and

operation of the operation means operates the pump such that a required amount of liquid is poured through the pouring spout.

If desired, the inlet pipe and the outlet pipe are covered with a protective tube.

Typically, the protective tube constitutes a corrugated tube.

Further typically, the pump is operated by an electric motor.

If desired, the electric motor is powered through mains power.

Practically, the inlet pipe is connected to a discharge opening of the bulk container through a connection adaptor.

According to some embodiments, the dispenser is mounted on a top surface of the refrigerator and is affixed thereto by means of a hollow guiding bolt that passes through a through bore at an upper wall of the refrigerator,

the hollow guiding bolt threadingly engages a stationary nut of the dispenser, and is secured by means of a tightening nut.

Advantageously, the inlet pipe freely passes through the hollow guiding bolt.

According to some embodiments, the dispenser comprises a dispenser base and a dispenser body that is connected thereto.

Practically, the dispenser body has a cylindrical peripheral surface, having a longitudinal axis, and an upper face that is slanted with respect to the longitudinal axis at a slant angle that is in the range of 20° to 70°.

If desired, the slant angle is 65°.

According to some embodiments, the dispenser base comprises a supporting bracket rising upwardly therefrom, the supporting bracket mounting thereon a pump and a switching power supply unit,

the switching power supply unit is connected to an electronic panel that powers an electric motor of the pump, and, control operating buttons of the dispenser.

Advantageously, the operating buttons comprise a first operating button, a second operating button and a third operating button, and wherein

pressing the first operating button induces a predetermined long serving of liquid,

pressing the second operating button induces a predetermined medium serving of liquid, and

a continuous pressing on the third operating button induces a continuous pouring of liquid as long as the third operating button is pressed.

Further advantageously, the refrigerator holding therein a multitude of bulk containers that are connected together to form a larger bulk container.

If desired, the dispenser comprises means for dispensing two different types of liquids, the means comprising at least an extra operating button and an additional pouring spout.

Advantageously, the liquid within the dispenser is continuously cooled through cold air that passes from the refrigerator through an hollow guiding bolt that connects between the refrigerator and the dispenser.

According to some embodiments, when the dispenser is not operated during a predetermined rest period of time the pump is operated in a reverse direction to press the liquid back to the bulk container.

According to a specific embodiment, the rest period of time is 30 seconds.

Practically, the dispenser comprises a power socket that detachably connects therein a power cable for supplying power from the mains.

### BRIEF DESCRIPTION OF THE DRAWINGS

For a better understanding of the present invention and to show how the same may be carried out in practice, reference will now be made to the accompanying drawings, in which:

FIG. 1 is a front perspective view of a milk dispenser according to the present invention;

FIG. 2 is a rear perspective view of the milk dispenser of FIG. 1; and

FIG. 3 is a side cross-sectional view of the milk dispenser of FIG. 1 placed on a refrigerator and connected to a milk bulk;

### DESCRIPTION OF PREFERRED EMBODIMENTS

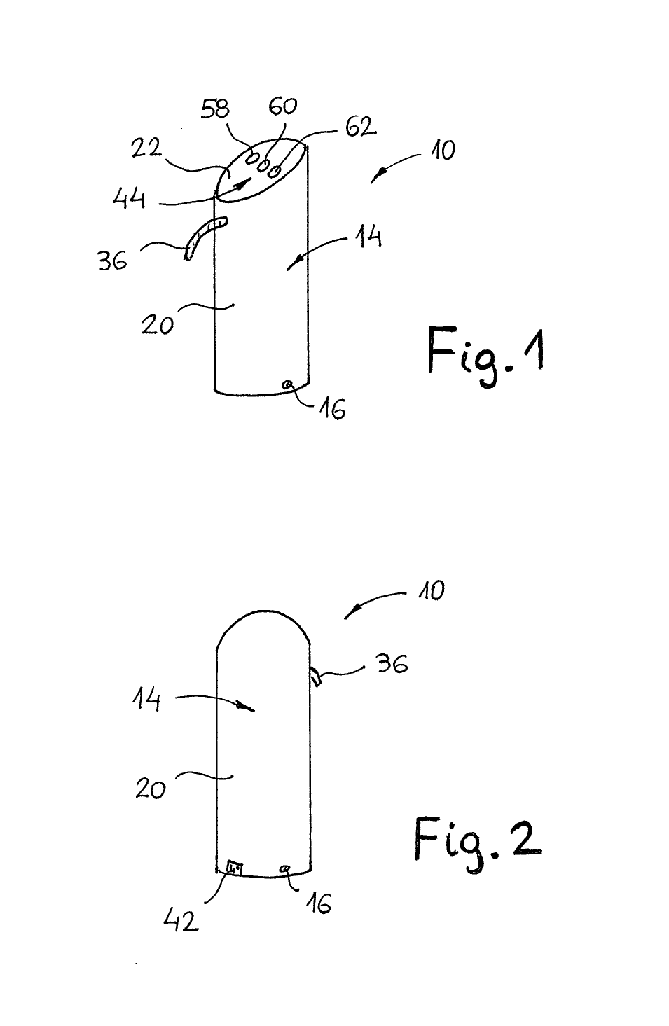

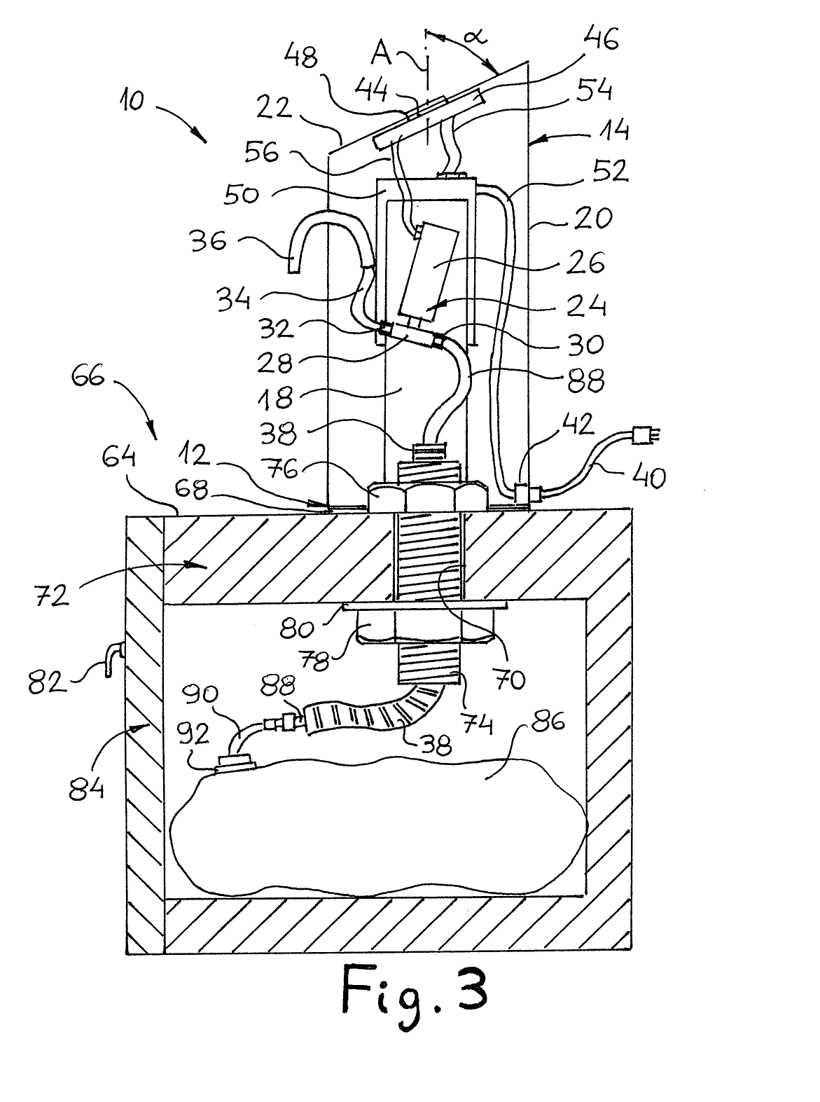

Attention is drawn to FIGS. 1 to 3 that show a milk dispenser 10 according to the present invention. For a matter of simplicity, the milk dispenser 10 will hereinafter be called “dispenser”. As shown, the dispenser 10, comprises a dispenser base 12 and a dispenser body 14 that is mounted on the dispenser base 12 and is attached thereto by means of a pair of fixing screws 16. For sanitation and sterilization reasons, and, for ensuring nice and shining look without any rust, stains, dirt, or deterioration influences, typically, all metal parts of the dispenser 10 are made of stainless steel.

It should be noted that directional terms appearing throughout the specification and claims, e.g. “forward”, “rear”, “upper”, “lower” etc., are used as terms of convenience to distinguish the location of various surfaces relative to each other. These terms are defined with reference to the figures, however, they are used for illustrative purposes only, and are not intended to limit the scope of the appended claims.

A supporting bracket 18 is connected to the dispenser base 12 and rising upwardly therefrom. The supporting bracket 18 may form a unitary piece with the dispenser base 12 or be rigidly connected thereto by, e.g., welding, riveting, screwing, quick connection, or the like.

According to some embodiments, the dispenser body 14 is cylindrical, having a longitudinal axis A. The dispenser body 14 has a peripheral surface 20 and an upper face 22. Typically, for a better appearance and for the ease of use, the upper face 22 is not perpendicularly directed with respect to the longitudinal axis A but is oblique with respect thereto. Typically, the upper face 22 is slanted at a slant angle α of 20° to 70° with respect to the longitudinal axis A. According to a specific embodiment of the present invention, the slant angle α is 65°.

The dispenser 10 comprises a pump 24 that is mounted on the supporting bracket 18. According to a specific embodiment of the present invention, the pump 24 comprises an electric motor 26 and a centrifugal impeller (not shown) seated within an impeller housing 28. The impeller housing 28 comprises an inlet hose 30 and an outlet hose 32. The outlet hose 32 is connected through an outlet pipe 34 to a pouring spout 36 that protrudes forwardly from the peripheral surface 20 of the dispenser body 14. The outlet pipe 34 is typically made of silicon and having an internal diameter of 8 mm and an outer diameter of 12 mm.

When it is desired to prevent the outlet pipe 34 from being folded and pinched, thus preventing the flow of fluid therethrough, a protective tube 38, typically, a corrugated tube, is assembled onto the outlet pipe 34. Further of preventing folding or pinching of the outlet pipe 34, the protective tube 38 provides substantial mechanical protection to the outlet pipe 34 against possible cutting by sharp edges of the dispenser, or by external tools when opening the dispenser for inspection or repairs.

The dispenser 10 is powered through an AC mains voltage of 220V by means of a power cable 40 that is connected to a power socket 42 that is connected to the dispenser base 12. The power socket 42 enables quick disconnection of the dispenser 10 from the power in a case of a problem, malfunction, maintenance, or when it is desired to remove the dispenser 10 from its place for cleaning purposes of the dispenser 10 or the surface underneath. When the treatment is finished, the power cable 40 can be easily and quickly re-connected to the power socket 42.

According to a specific embodiment of the present invention, the dispenser 10 is provided with three operating buttons 44 that form a part of an electronic panel 46 that is connected at a lower side of the upper face 22 of the dispenser body 14. The operating buttons 44 are covered and pressed through a resilient, spill-proof buttons cover 48 that forms a unitary piece.

A switching power supply unit 50 is attached to the supporting bracket 18. The switching power supply unit 50 is connected by means of an electric cable 52 to the power socket 42, and, by means of a pair of electrical wires 54 to the electronic panel 46. In addition, the electric motor 26 is connected to the electronic panel 46 by means of a pair of voltage wires 56. For practical and safety reasons, the components of the dispenser 10 operate at a low voltage of 24V through the switching power supply unit 50.

The operating buttons 44 are arranged such that pressing a first operating button 58 induces a long serving of liquid, i.e., milk at the present use of the dispenser 10, of a quantity that is pre-adjusted. Pressing a second operating button 60, positioned adjacent the first operating button 58, induces a medium serving of milk, of a quantity that is pre-adjusted. A continuous pressing on a third operating button 62, positioned adjacent the second operating button 60, induces continuous pouring of milk as long as the third operating button 62 is being pressed. Cease of pressing on the third operating button 62 ceases the flow of milk through the pouring spout 36.

The dispenser 10 is positioned, in most practical cases, on a top surface 64 of an industrial refrigerator 66 that is commonly found in places which serve coffee. Since the top surface 64 of the refrigerator 66 serves as a handling table, is easily allocates thereon the dispenser 10. Typically, the dispenser 10 is placed on a supporting base 68 made of EPDM that is positioned between the dispenser base 12 and the top surface 64 of the refrigerator 66. The supporting base 68 provides resiliency, insulation, stability, and prevents water from entering under the dispenser 10.

In order to fix the dispenser 10 in its position, first, a large-diameter through bore 70 is drilled through the top surface 64 of the refrigerator 66, namely, through an upper wall 72 of the refrigerator 66 and perpendicularly thereto. A hollow guiding bolt 74 is passed through the through bore 70 and threadingly engages a stationary nut 76 that is fixedly connected to the dispenser base 12, typically by welding. The hollow guiding bolt 74 has an external diameter that is similar to the diameter of the through bore 70 and slightly smaller therefrom.

A tightening nut 78, provided with an integral washer 80 at an upper portion thereof, is threadingly engaging a lower portion of the hollow guiding bolt 74. When the tightening nut 78 is fully tightened, it firmly fixes the dispenser 10 against the top surface 64 of the refrigerator 66. Since the hollow guiding bolt 74 is of a large diameter, and, by means of the large tightening nut 78 and the large integral washer 80, a large downwardly directed axial force is applied on the dispenser 10 against the top surface 64 of the refrigerator 66. Furthermore, since the hollow guiding bolt 74 has an external diameter that is similar to the diameter of the through bore 70, the upper wall 72 practically prevents any tilting of the hollow guiding bolt 74 and, thereby, of the dispenser 10 as a whole.

By the construction of the hollow guiding bolt 74 and the tightening nut 78 together with the integral washer 80, it is guaranteed that a single length hollow guiding bolt 74 may serve to be installed at upper walls 72 of different refrigerators 66 having different thicknesses of their upper walls 72.

In order to insert milk into the refrigerator 66, the refrigerator 66 is opened by means of a handle 82 of a refrigerator door 84. Then, a bulk container of milk 86 is placed within the refrigerator 66. Some industrial bulk containers existing in the market are 17-liters-volume plastic bags. Some of the bags may be connected together so that the refrigerator 66 holds, in a full position of the bulk containers, a bulk of 34 liters of milk.

An inlet pipe 88, similar to the outlet pipe 34 as described above, is connected to the inlet hose 30, passes through the hollow guiding bolt 74, and connects to a connection adaptor 90 that engages a discharge opening 92 of the bulk container of milk 86. The inlet pipe 88 is covered with a protective tube 38 as described above with respect to the outlet pipe 34.

Since the hollow guiding bolt 74 is of a large diameter, substantially larger than a diameter of the protective tube 38, the cool air within the refrigerator 66 may pass through the hollow guiding bolt 74 and gradually mix with the air inside the dispenser 10. In this position, the milk is kept in the bulk container of milk 86 and it is stored continuously in refrigeration, including the piping conveying the milk. Furthermore, in some cases, when it is desired, the dispenser 10 is set such that if it is not in use for thirty seconds, the pump XX operates in a reverse direction and presses the milk back into the bulk container of milk 86. Thus, by being continuously in cold temperature, the milk being much easier foamed as required prior to being served to a customer.

When it is required to pour milk into a foaming jug, the appropriate operating button 44 is pressed according to the need. As can be appreciated by a person skilled in the art, the process described herein is much more sterile comparing to the prior art process described above. Furthermore, the process is time saving since the operator does not have to frequently replace a 1 liter milk container. Also, since cold milk can be added to the foaming jug at an instant, a beginner operator may save a considerable amount of milk that would have been thrown away if used according to prior art methods.

Although the present invention has been described to a certain degree of particularity, it should be understood that various alterations and modifications could be made without departing from the spirit or scope of the invention as hereinafter claimed.

For example, the milk dispenser does not have to be provided with three operating buttons and in other embodiments the milk dispenser is provided with other numbers of operating buttons.

Furthermore, the milk dispenser is not necessarily operated through operating buttons. In other embodiments, the milk dispenser may be provided with mechanically pressed operating knobs, or, with a digital operating panel that is a “touch panel” through which the operator may decide upon the mode of pouring the milk.

The milk dispenser does not have to be cylindrical and it may be formed of other shapes, i.e., different shapes and sizes of dispenser body or dispenser base platforms, to suit specific needs and operation capacity. For example, the operating buttons, the electrical pump and the control panel may be connected to a unified frame that may be closed by a one-side cover.

The pouring spout may be differently constructed and directed. It may be formed from stainless steel, chrome plated steel, titanium plating, silicone, plastic, or other suitable materials.

The electrical pump does not have to be operated by 24V through a transformer and it may be operated directly from the mains. The electrical pump may be operated by an AC voltage of 110V or 220V. Furthermore, when the electrical pump is fed through a transformer and controlled by an operating panel, it may be capable of being plugged into an AC mains voltage of 110V or 220V without the necessity of the operator to pre-set the supply voltage.

In some embodiments, when it is required to distinguish between regular-fat milk (3%) or low-fat milk (1%), the milk dispenser may be provided with an additional fat-set-button. In these cases, if it is desired, the milk dispenser may be provided with an additional spout.

The bulk container of milk does not have to be of a soft spatial structure as described above, and, it may have a rigid form of container made of cardboard, plastic, metal, or the like. Furthermore, a multitude of bulk containers may be connected together within the refrigerator, to form a larger bulk container. In any of these cases, it should be guaranteed that the connection adaptor fits the openings of the rigid containers.

1. A dispenser (10) for dispensing liquid from a bulk container (86), the dispenser being mounted outside of a refrigerator (66) and comprises: means for conveying the liquid from the bulk container to a pouring spout (36).

2. The dispenser (10) according to claim 1, wherein:
the dispenser constitutes a milk dispenser.

3. The dispenser (10) according to claim 1, wherein:
the bulk container constitutes a milk bulk container (86).

4. The dispenser (10) according to claim 1, wherein:
the bulk container is stored within the refrigerator (66).

5. The dispenser (10) according to claim 1, wherein:
the means for conveying the liquid from the bulk container to the pouring spout comprising:
a pump (24) having an inlet hose (30) and an outlet hose (32), and
operation means (44) for dispensing a required amount of liquid, wherein:
an inlet pipe (88) is connected between the inlet hose and the bulk container;
an outlet pipe (34) is connected between the outlet hose and the pouring spout; and
operation of the operation means operates the pump such that a required amount of liquid is poured through the pouring spout.

6. The dispenser (10) according to claim 5, wherein:
the inlet pipe (88) and the outlet pipe (34) are covered with a protective tube (38).

7. The dispenser (10) according to claim 6, wherein:
the protective tube (38) constitutes a corrugated tube.

8. The dispenser (10) according to claim 5, wherein:
the pump is operated by an electric motor.

9. The dispenser (10) according to claim 8, wherein:
the electric motor is powered through mains power.

10. The dispenser (10) according to claim 5, wherein:
the inlet pipe is connected to a discharge opening (92) of the bulk container (86) through a connection adaptor (90).

11. The dispenser (10) according to claim 1, wherein:
the dispenser is mounted on a top surface of the refrigerator and is affixed thereto by means of a hollow guiding bolt that passes through a through bore (70) at an upper wall (72) of the refrigerator,
the hollow guiding bolt threadingly engages a stationary nut (76) of the dispenser, and is secured by means of a tightening nut (78).

12. The dispenser (10) according to claim 11, wherein:
the inlet pipe (88) freely passes through the hollow guiding bolt.

13. The dispenser (10) according to claim 1, wherein:
the dispenser comprises a dispenser base (12) and a dispenser body (14) that is connected thereto.

14. The dispenser (10) according to claim 1, wherein:
the dispenser body has a cylindrical peripheral surface (20), having a longitudinal axis (A), and an upper face (22) that is slanted with respect to the longitudinal axis at a slant angle (α) that is in the range of 20° to 70°.

15. The dispenser (10) according to claim 14, wherein:
the slant angle (α) is 65°.

16. The dispenser (10) according to claim 13, wherein:
the dispenser base comprises a supporting bracket (18) rising upwardly therefrom, the supporting bracket mounting thereon a pump (24) and a switching power supply unit (50),
the switching power supply unit is connected to an electronic panel (46) that powers an electric motor (26) of the pump, and, control operating buttons (44) of the dispenser.

17. The dispenser (10) according to claim 16, wherein:
the operating buttons comprise a first operating button (58), a second operating button (60) and a third operating button (62), and wherein
pressing the first operating button induces a predetermined long serving of liquid,
pressing the second operating button induces a predetermined medium serving of liquid, and
a continuous pressing on the third operating button induces a continuous pouring of liquid as long as the third operating button is pressed.

18. The dispenser (10) according to claim 1, wherein:
the refrigerator (66) holding therein a multitude of bulk containers (86) that are connected together to form a larger bulk container.

19. The dispenser (10) according to claim 5, wherein:
the dispenser comprises means for dispensing two different types of liquids, the means comprising at least an extra operating button and an additional pouring spout.

20. The dispenser (10) according to claim 1, wherein:
the liquid within the dispenser is continuously cooled through cold air that passes from the refrigerator through an hollow guiding bolt that connects between the refrigerator and the dispenser.

21. The dispenser (10) according to claim 5, wherein:
when the dispenser is not operated during a predetermined rest period of time the pump is operated in a reverse direction to press the liquid back to the bulk container.

22. The dispenser (10) according to claim 21, wherein:
the rest period of time is 30 seconds.

23. The dispenser (10) according to claim 1, wherein:
the dispenser comprises a power socket (42) that detachably connects therein a power cable (40) for supplying power from the mains.
